(19) United States
(12) Patent Application Publication
(10) Pub. No.: US 2023/0387838 A1
(43) Pub. Date: Nov. 30, 2023

(54) METHOD OF CONTROLLING A BRUSHLESS PERMANENT-MAGNET MOTOR

(71) Applicant: Dyson Technology Limited, Wiltshire (GB)

(72) Inventors: George Francis Paul OAKHAM, Calne (GB); Christopher John BATEMAN, Swindon (GB)

(73) Assignee: Dyson Technology Limited, Wiltshire (GB)

(21) Appl. No.: 18/029,635

(22) PCT Filed: Sep. 29, 2021
(86) PCT No.: PCT/GB2021/052518

§ 371 Date: Mar. 30, 2023

(30) Foreign Application Priority Data
Oct. 8, 2020 (GB) 2015947.1

(51) Int. Cl. H02P 6/15; A47L 9/28; A45D 20/00

(52) U.S. Cl. CPC H02P 6/157; A47L 9/2842; A45D 20/00

(57) ABSTRACT

A method of controlling a brushless permanent-magnet motor having a phase winding and a rotor includes monitoring a value indicative of back EMF induced in the phase winding during oscillation of the rotor about a parking position, and using amplitude peaks of the value indicative of back EMF to calculate a time window in which to apply a drive voltage to the phase winding. The method includes setting a timer corresponding to the time window at a subsequent determined amplitude peak and applying a drive voltage to the phase winding during the time window.

### FIELD OF THE INVENTION

The present invention relates to a method of controlling a brushless permanent-magnet motor.

### BACKGROUND OF THE INVENTION

In some cases where a brushless permanent-magnet motor has been shut-down, i.e. turned-off during operation, it may be desirable to re-start the motor before the rotor is stationary at its parking position, for example where the rotor is still oscillating about the parking position. Knowledge of the parking position may be important so that the appropriate polarity of voltage may be applied to a phase winding to re-start the motor, and knowledge of the rotor position relative to the parking position may be important to determine when to apply a voltage to the phase-winding to re-start the motor. In known brushless-permanent magnet motors it is not possible to detect the parking position and the rotor position relative to the parking position when the rotor is oscillating without a physical position sensor. This means that the motor may not be able to safely re-start in a forward direction until the rotor is stationary, which may cause delays to a user of a product comprising the brushless permanent magnet motor that are considered unacceptable.

### SUMMARY OF THE INVENTION

According to a first aspect of the present invention there is provided a method of controlling a brushless permanent-magnet motor having a phase winding and a rotor, the method comprising: monitoring a value indicative of back EMF induced in the phase winding during oscillation of the rotor about a parking position; using amplitude peaks of the value indicative of back EMF to calculate a time window in which to apply a drive voltage to the phase winding; setting a timer corresponding to the time window at a subsequent determined amplitude peak; and applying a drive voltage to the phase winding during the time window.

Brushless permanent-magnet motors typically have saliency, usually provided by an asymmetric stator tooth design, to enable the motor to always start from stationary in a forward direction. Such saliency leads to the flux linkage into the motor winding being asymmetric about a parking position of the rotor, for example with the peak flux linkage offset from the parking position of the rotor. The inventors of the present application have found that the magnitude of back EMF induced in the phase winding varies as the rotor oscillates about a parking position, with the variation depending on the parking position about which the rotor is oscillating in view of the asymmetric flux linkage about the parking position.

The inventors of the present application have recognised that such variation in magnitude of back EMF can be used to indicate the relative position of the rotor to the parking position.

Transitions of back EMF from positive amplitude to negative amplitude or vice versa, i.e. zero-crossings of back EMF induced in the phase winding, either occur when the rotor is at the parking position, or when the rotor is at one of two boundary points of oscillation about the parking position, with peaks in amplitude of back EMF occurring as the rotor moves between the boundaries of oscillation and the parking position. The inventors of the present application have recognised that both positive and negative amplitude peaks of back EMF induced in the phase winding vary depending on whether the rotor is travelling from a first boundary point of oscillation to a second boundary point of oscillation, or from the second boundary point of oscillation to the first boundary point of oscillation, in view of the asymmetry in flux linkage either side of the parking position. By monitoring the amplitude peaks of back EMF a direction of motion of the rotor relative to the parking position may be inferred, and by using the amplitude peaks a time window can be calculated within which it is considered that an applied drive voltage will drive the rotor in a forward, rather than a backward, direction.

By inferring the direction of the rotor in such a manner and determining when an applied voltage will drive the rotor in a forward, rather than a backward, direction, the motor may be re-started during oscillation, which may reduce a delay of re-start compared to, for example, a motor where it is required to wait until the rotor is considered to be stationary for re-start to occur.

The method may comprise a sensorless method of controlling a brushless permanent-magnet motor, for example a method of controlling a brushless permanent-magnet motor that does not comprise a position sensor.

The time window may comprise a time window when the motor can be started in a forward direction with minimal risk of being started in a backward direction. Applying a drive voltage to the phase winding during the time window may comprise applying a drive voltage to the phase winding to drive the motor in a forward direction, for example to bring the rotor out of oscillation. The time window may correspond to a rotor positional range when the motor can be started in a forward direction with minimal risk of being started in a backward direction.

The method may comprise using negative amplitude peaks of the value indicative of back EMF to calculate the time window in which to apply the drive voltage to the phase winding.

The method may comprise using positive amplitude peaks of the value indicative of back EMF to calculate the time window in which to apply the drive voltage to the phase winding.

The method may comprise using a time difference between a consecutive negative amplitude peak and positive amplitude peak of the value indicative of back EMF to calculate the time window.

The parking position may one of a first parking position and a second parking position, the first parking position may comprise a positive parking position, and the second parking position may comprise a negative parking position.

Where the rotor is oscillating about a positive parking position, the method may comprise using high negative amplitude peaks of the value indicative of back EMF to calculate the time window in which to apply the drive voltage to the phase winding. Where the rotor is in a negative parking position, the method may comprise using low negative amplitude peaks of the value indicative of back EMF to calculate the time window in which to apply the drive voltage to the phase winding.

Where the rotor is oscillating about a positive parking position, the method may comprise using low positive amplitude peaks of the value indicative of back EMF to calculate the time window in which to apply the drive voltage to the phase winding. Where the rotor is oscillating about a negative parking position, the method may comprise using high positive amplitude peaks of the value indicative of back EMF to calculate the time window in which to apply the drive voltage to the phase winding.

The method may comprise using a time difference between a low positive amplitude peak and a high negative amplitude peak to calculate the time window when the rotor is oscillating about the first parking position, and the method may comprise using a time difference between a low negative amplitude peak and a high positive amplitude peak to calculate the time window when the rotor is oscillating about the second parking position.

Where the parking position comprises a positive parking position, the back EMF induced in the phase winding may transition from positive amplitude to negative amplitude at the parking position of the rotor, and may transition from negative amplitude to positive amplitude at a boundary position of oscillation of the rotor. A lower positive amplitude peak may be experienced when the rotor travels from a backward boundary of oscillation to the parking position in a forward direction when compared to a higher positive amplitude peak experienced when the rotor travels from a forward boundary of oscillation to the parking position in a backward direction. A higher negative amplitude peak may be experienced when the rotor travels from the parking position to a forward boundary of oscillation in a forward direction when compared to a lower negative amplitude peak experienced when the rotor travels from the parking position to a backward boundary of oscillation in a backward direction. Thus the variation in amplitude peaks in the value indicative of back EMF may be used to infer a direction in which the rotor is moving relative to the parking position.

Where the parking position comprises a negative parking position, the back EMF induced in the phase winding may transition from negative amplitude to positive amplitude at the parking position of the rotor, and may transition from positive amplitude to negative amplitude at a boundary position of oscillation of the rotor. A higher positive amplitude peak may be experienced when the rotor travels from the parking position to a forward boundary of oscillation in a forward direction when compared to a lower positive amplitude peak experienced when the rotor travels from the parking position to a backward boundary of oscillation in a backward direction. A lower negative amplitude peak may be experienced when the rotor travels from a backward boundary of oscillation to the parking position in a forward direction when compared to a higher negative amplitude peak experienced when the rotor travels from a forward boundary of oscillation to the parking position in a backward direction. Thus the variation in amplitude peaks in the value indicative of back EMF may be used to infer a direction in which the rotor is moving relative to the parking position.

A high amplitude peak and a low amplitude peak may be determined by monitoring two consecutive amplitude peaks of the same polarity, and designating the peak of the two consecutive amplitude peaks of the same polarity having a higher amplitude as a high amplitude peak, and designating the peak of the two consecutive amplitude peaks of the same polarity having a lower amplitude as a low amplitude peak.

The drive voltage may be applied to the phase winding at a halfway point of the time window. The drive voltage may be applied to the phase winding when the value indicative of back EMF induced in the phase winding is zero.

The method may comprise identifying whether the parking position of the rotor is a first parking position or a second parking position, and determining a voltage polarity of the drive voltage to be applied to the phase winding based on the determined first or second parking position. This may enable an appropriate polarity of voltage to be applied to the phase winding to ensure start of the rotor in a forward direction when exiting oscillation.

The method may comprise identifying a pattern in amplitude peaks of the value indicative of back EMF, and using the pattern in amplitude peaks of the value indicative of back EMF to determine whether the parking position of the rotor is the first parking position or the second parking position.

A pattern in amplitude peaks of the value indicative of back EMF may comprise a predefined sequence of low and high positive and negative amplitude peaks.

The method may comprise identifying a pattern in negative amplitude peaks of the value indicative of back EMF to determine whether the parking position of the rotor is the first parking position or the second parking position.

The method may comprise identifying a pattern in positive amplitude peaks of the value indicative of back EMF to determine whether the parking position of the rotor is the first parking position or the second parking position.

The first parking position may be determined where a high positive amplitude peak is followed by a low negative amplitude peak and/or where a low positive amplitude peak is followed by a high negative amplitude peak.

The second parking position may be determined where a high positive amplitude peak is followed by a high negative amplitude peak and/or where a low negative amplitude peak is followed by a low negative amplitude peak.

As mentioned above, where the parking position comprises a positive parking position, the back EMF induced in the phase winding may transition from positive amplitude to negative amplitude at the parking position of the rotor, and may transition from negative amplitude to positive amplitude at a boundary position of oscillation of the rotor. A lower positive amplitude peak may be experienced when the rotor travels from a backward boundary of oscillation to the parking position in a forward direction when compared to a higher positive amplitude peak experienced when the rotor travels from a forward boundary of oscillation to the parking position in a backward direction. A higher negative amplitude peak may be experienced when the rotor travels from the parking position to a forward boundary of oscillation in a forward direction when compared to a lower negative amplitude peak experienced when the rotor travels from the parking position to a backward boundary of oscillation in a backward direction. Thus the variation in amplitude peaks in the value indicative of back EMF may be used to infer a parking position of the rotor.

Where the parking position comprises a negative parking position, the back EMF induced in the phase winding may transition from negative amplitude to positive amplitude at the parking position of the rotor, and may transition from positive amplitude to negative amplitude at a boundary position of oscillation of the rotor. A higher positive amplitude peak may be experienced when the rotor travels from the parking position to a forward boundary of oscillation in a forward direction when compared to a lower positive amplitude peak experienced when the rotor travels from the parking position to a backward boundary of oscillation in a backward direction. A lower negative amplitude peak may be experienced when the rotor travels from a backward boundary of oscillation to the parking position in a forward direction when compared to a higher negative amplitude peak experienced when the rotor travels from a forward boundary of oscillation to the parking position in a backward direction. Thus the variation in amplitude peaks in the value indicative of back EMF may be used to infer a parking position of the rotor.

The method may comprise identifying a pattern in amplitude peaks of the value indicative of back EMF over at least four amplitude peaks.

The method may comprise monitoring a value indicative of back EMF prior to oscillation of the rotor about the parking position, and identifying a polarity of the value indicative of back EMF prior to oscillation to determine whether the parking position of the rotor is the first parking position or the second parking position.

The first parking position may be determined where a positive polarity of the value indicative of back EMF is identified prior to entry of the rotor into oscillation, and the second parking position may be determined where a negative polarity of the value indicative of back EMF is identified prior to entry of the rotor into oscillation.

According to a second aspect of the present invention there is provided a method of controlling a brushless permanent-magnet motor having a phase winding and a rotor, the method comprising: monitoring a value indicative of back EMF induced in the phase winding during oscillation of the rotor about a parking position; identifying a pattern in amplitude peaks of the value indicative of back EMF; using the pattern in amplitude peaks of the value indicative of back EMF to determine whether the parking position of the rotor is a first parking position or a second parking position; determining a polarity of drive voltage to be applied to the phase winding dependent on the determined first or second parking position; and applying a drive voltage having the determined polarity to the phase winding.

The method may comprise identifying a pattern in negative amplitude peaks of the value indicative of back EMF to determine whether the parking position of the rotor is the first parking position or the second parking position.

The method may comprise identifying a pattern in positive amplitude peaks of the value indicative of back EMF to determine whether the parking position of the rotor is the first parking position or the second parking position.

The first parking position may be determined where a high positive amplitude peak is followed by a low negative amplitude peak and/or where a low positive amplitude peak is followed by a high negative amplitude peak.

The second parking position may be determined where a high positive amplitude peak is followed by a high negative amplitude peak and/or where a low negative amplitude peak is followed by a low negative amplitude peak.

The first parking position may comprise a positive parking position, for example a parking position where the rotor is aligned between two north poles of a stator of the motor, and the second position may comprise a negative parking position, for example a parking position where the rotor is aligned between two south poles of the stator of the motor.

The determined polarity of drive voltage may comprise a positive polarity where the rotor is oscillating about a positive parking position, and the determined polarity of drive voltage may comprise a negative polarity where the rotor is oscillating about a negative parking position.

According to a third aspect of the present invention there is provided a brushless permanent-magnet motor comprising a stator, a phase winding wound about the stator, a rotor rotatable relative to the stator, and a control system to perform a method according to the first or second aspects of the present invention.

The control system may comprise an inverter, a gate driver module, a controller, and a current sensor, the inverter coupled to the phase winding, the gate driver module to drive opening and closing of switches of the inverter in response to control signals output by the controller, and the current sensor to output a signal that provides a measure of the current in the phase winding.

According to a fourth aspect of the present invention there is provided a floorcare device comprising a brushless permanent-magnet motor according to the second aspect of the present invention.

According to a fifth aspect of the present invention there is provided a haircare appliance comprising a brushless permanent-magnet motor according to the second aspect of the present invention.

According to a sixth aspect of the present invention there is provided a method of controlling a brushless permanent-magnet motor having a phase winding and a rotor, the method comprising: monitoring a value indicative of back EMF induced in the phase winding during oscillation of the rotor about a parking position; identifying a pattern in amplitude peaks of the value indicative of back EMF; using the pattern in amplitude peaks of the value indicative of back EMF to determine whether the parking position of the rotor is a first parking position or a second parking position; determining a voltage polarity of the drive voltage to be applied to the phase winding based on the determined first or second parking position; using the amplitude peaks of the value indicative of back EMF to calculate a time window in which to apply a drive voltage to the phase winding; setting a timer corresponding to the time window at a subsequent determined amplitude peak; and applying a drive voltage to the phase winding during the time window.

Optional features of aspects of the present invention may be equally applied to other aspects of the present invention, where appropriate.

### BRIEF DESCRIPTION OF THE DRAWINGS

FIG. 1 is a first schematic view illustrating a motor system;

FIG. 2 is a second schematic view illustrating a motor system;

FIG. 3 is a table indicating switching states of the motor system of FIGS. 1 and 2;

FIG. 4 is a graph illustrating a known shutdown sequence of the motor system of FIGS. 1 and 2;

FIG. 5 is a schematic illustration of parking positions of a rotor of the motor system of FIGS. 1 and 2;

FIG. 6 is a graph illustrating variation of flux linkage about a parking position of the rotor of the motor system of FIGS. 1 and 2;

FIG. 7 is a diagram illustrating back EMF induced in a phase winding of the motor system of FIGS. 1 and 2 during oscillation about a first parking position;

FIG. 8 is a diagram illustrating back EMF induced in a phase winding of the motor system of FIGS. 1 and 2 during oscillation about a second parking position;

FIG. 9 is a graph illustrating a shutdown sequence of the motor system of FIGS. 1 and 2 according to the present invention;

FIG. 10 is a flow diagram illustrating a first method according to the present invention;

FIG. 11 is a flow diagram illustrating a second method according to the present invention

FIG. 12 is a schematic illustration of a floorcare device in accordance with the present disclosure;

FIG. 13 is a schematic illustration of a haircare appliance in accordance with the present disclosure.

### DETAILED DESCRIPTION OF THE INVENTION

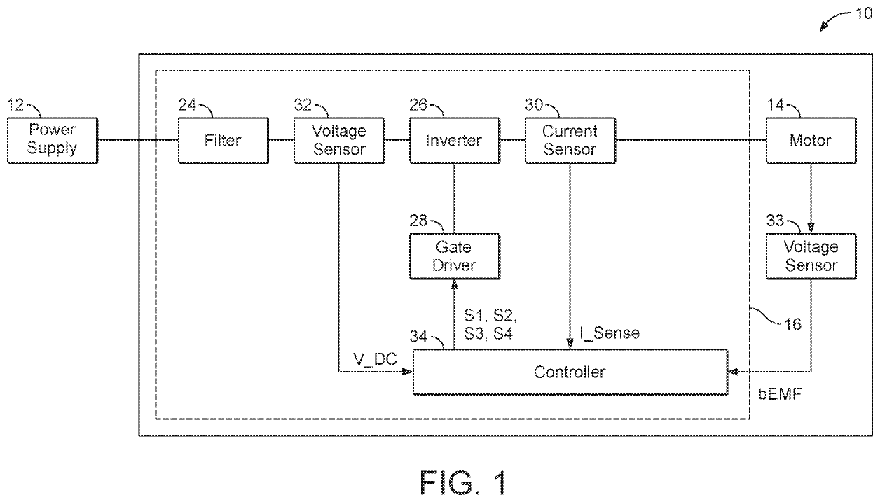

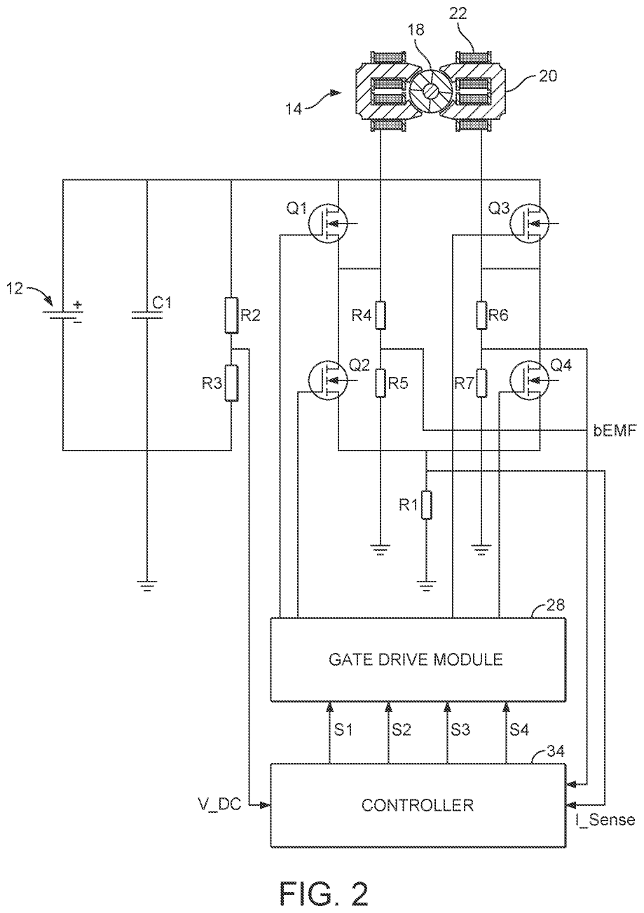

A motor system, generally designated 10, is shown in FIGS. 1 and 2. The motor system 10 is powered by a DC power supply 12, for example a battery, and comprises a brushless permanent magnet motor 14 and a control circuit 16. It will be recognised by a person skilled in the art that the methods of the present invention may be equally applicable to a motor system powered by an AC power supply, with appropriate modification of the circuitry, for example to include a rectifier.

The motor 14 comprises a four-pole permanent-magnet rotor 18 that rotates relative to a four-pole stator 20. Although shown here as a four-pole permanent magnet rotor, it will be appreciated that the present invention may be applicable to motors having differing numbers of poles, for example eight poles. Conductive wires wound about the stator 20 are coupled together to form a single-phase winding 22. Whilst described here as a single-phase motor, it will be recognised by a person skilled in the art that the teachings of the present application may also be applicable to multiphase, for example three-phase, motors.

The control circuit 16 comprises a filter 24, an inverter 26, a gate driver module 28, a current sensor 30, a first voltage sensor 32, a second voltage sensor 33 and a controller 34.

The filter 24 comprises a link capacitor C1 that smooths the relatively high-frequency ripple that arises from switching of the inverter 26.

The inverter 26 comprises a full bridge of four power switches Q1-Q4 that couple the phase winding 22 to the voltage rails. Each of the switches Q1-Q4 includes a freewheel diode.

The gate driver module 28 drives the opening and closing of the switches Q1-Q4 in response to control signals received from the controller 34.

The current sensor 30 comprises a shunt resistor R1 located between the inverter and the zero-volt rail. The voltage across the current sensor 30 provides a measure of the current in the phase winding 22 when connected to the power supply 12. The voltage across the current sensor 30 is output to the controller 33 as signal, I_SENSE. It will be recognised that in this embodiment it is not possible to measure current in the phase winding 22 during freewheeling, but that alternative embodiments where this is possible, for example via the use of a plurality of shunt resistors, are also envisaged.

The first voltage sensor 32 comprises a voltage divider in the form of resistors R2 and R3, located between the DC voltage rail and the zero-volt rail. The voltage sensor outputs a signal, V_DC, to the controller 34 that represents a scaled-down measure of the supply voltage provided by the power supply 12.

The second voltage sensor 33 comprises a pair of voltage dividers constituted by resistors R4, R5, R6, and R7, that are connected either side of the phase winding 22. The second voltage sensor 33 provides a signal indicative of back EMF induced in the phase winding 22 to the controller, as bEMF.

The controller 34 comprises a microcontroller having a processor, a memory device, and a plurality of peripherals (e.g. ADC, comparators, timers etc.). In an alternative embodiment, the controller 34 may comprise a state machine. The memory device stores instructions for execution by the processor, as well as control parameters that are employed by the processor during operation. The controller 34 is responsible for controlling the operation of the motor 14 and generates four control signals S1-S4 for controlling each of the four power switches Q1-Q4. The control signals are output to the gate driver module 28, which in response drives the opening and closing of the switches Q1-Q4.

During normal operation, the controller 34 estimates the position of the rotor 18 using a sensorless control scheme, i.e. without the use of a Hall sensor or the like, by using software to estimate a waveform indicative of back EMF induced in the phase winding 22 via the signals V_DC and I_SENSE. The details of such a control scheme will not be described here for the sake of brevity, but can be found, for example, in GB patent application no. 1904290.2. Another sensorless control scheme that utilises hardware components to estimate back EMF induced in the phase winding 22 is disclosed in published PCT patent application WO2013132247A1. With knowledge of the position of the rotor 18 in normal operation, the controller 34 generates the control signals S1-S4.

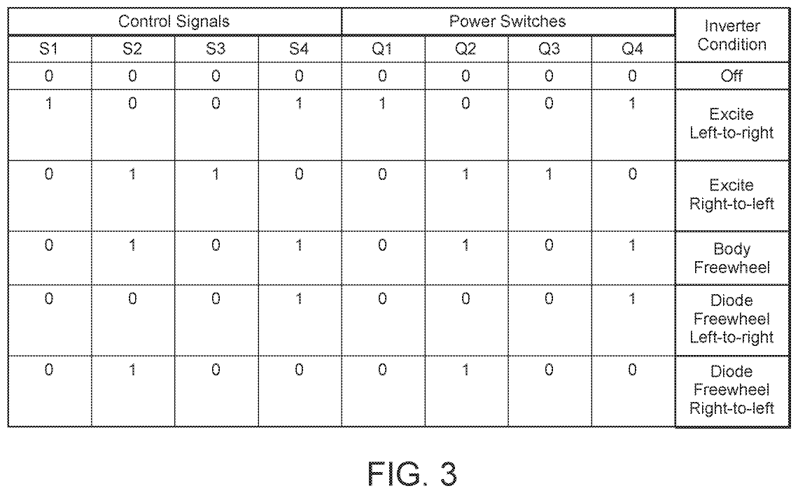

FIG. 3 summarises the allowed states of the switches Q1-04 in response to the control signals S1-S4 output by the controller 33. Hereafter, the terms ‘set and ‘clear’ will be used to indicate that a signal has been pulled logically high and low respectively. As can be seen from FIG. 3, the controller 34 sets S1 and S4, and clears S2 and S3 in order to excite the phase winding 22 from left to right. Conversely, the controller 34 sets S2 and S3, and clears S1 and S4 in order to excite the phase winding 22 from right to left. The controller 34 clears S1 and S3, and sets S2 and S4 in order to freewheel the phase winding 22. Freewheeling enables current in the phase winding 22 to re-circulate around the low-side loop of the inverter 26. In the present embodiment, the power switches Q1-Q4 are capable of conducting in both directions. Accordingly, the controller 34 closes both low-side switches Q2, Q4 during freewheeling such that current flows through the switches Q2, Q4 rather than the less efficient diodes.

Conceivably, the inverter 26 may comprise power switches that conduct in a single direction only. In this instance, the controller 34 would clear S1, S2 and S3, and set S4 so as to freewheel the phase winding 22 from left to right. The controller 34 would then clear S1, S3 and S4, and set S2 in order to freewheel the phase winding 22 from right to left. Current in the low-side loop of the inverter 26 then flows down through the closed low-side switch (e.g. Q4) and up through the diode of the open low-side switch (e.g. Q2).

Appropriate control of the switches Q1-Q4 can be used to drive the rotor 18 at speeds up to or in excess of 100 krpm during normal operation, for example in a steady-state mode.

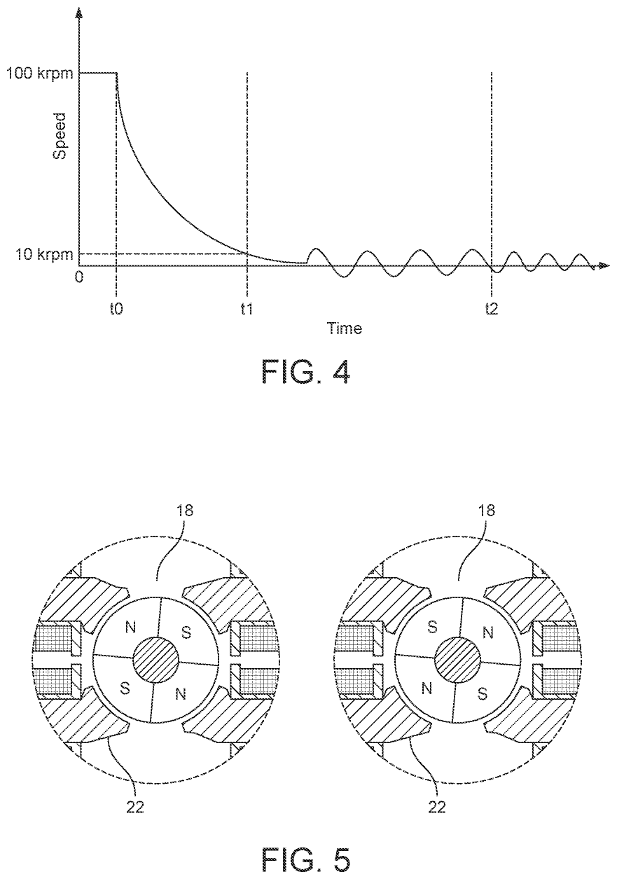

A shutdown sequence of the motor 14 is illustrated in FIG. 4. Before time t0, the motor is operating in steady-state mode at a speed of around 100 krpm. The shutdown sequence is initiated at time t0, and between time t0 and t1 active braking is applied to the motor, for example by applying appropriate voltages to selected ones of switches Q1-Q4. This causes the motor to decelerate. During the time period t0-t1, the position of the rotor 18 can be monitored. In particular, the signal bEMF from the voltage sensor 33 is periodically monitored by turning switches Q1-Q4 off, and when the voltage transitions from negative to positive or positive to negative a phase voltage zero-crossing is deemed to occur. This allows the motor 14 to be re-started, if needed, during the time period t0-41. The time period t0-t1 may be around 150-300 ms.

At time t1 the speed of the rotor 18 has dropped to around 10 krpm. Between time t1 and t2, the rotor 18 begins to oscillate about a parking position of the rotor 18. During oscillation it may not be possible to determine a zero-crossing, and hence the position of the rotor 18 is unknown, and the motor 14 cannot be restarted as there is a risk that, without knowledge of the rotor position, an attempted restart may result in the rotor 18 spinning backwards. After time t2, the oscillations are considered small enough that the motor 14 can be safely restarted in the forward direction.

The time period between t1 and t2 may typically be in the region of 200-500 ms. Whilst this period can be reduced, for example by utilising freewheeling of the switches Q2 and Q4 to damp oscillation, the time period in which the motor 14 cannot be restarted may still be perceptible to a user. Such a delay may give the user a false impression of failure of the product in which the motor 14 is housed, and hence may be undesirable.

The inventors of the present application have determined a way to monitor position of the rotor 18 during oscillation such that the motor 14 can be restarted with minimal delay during a shutdown procedure, i.e. during oscillation of the rotor 18 about the parking position.

The motor 14 is provided with saliency to ensure that the rotor 18 parks in a known position that will enable the rotor 18 to be restarted in a forward direction from stationary. Such saliency is typically provided in the form of an asymmetric stator tooth design, as seen in FIG. 5, which also illustrates the rotor 18 parked in one of two positions, which can be considered positive and negative parking positions. Although referred to as two parking positions, it will be appreciated that the rotor 18 has four parking positions, but that the four parking positions can be thought of as two parking positions in view of the rotational symmetry of the rotor 18.

Knowledge of which parking position the rotor 18 is oscillating about enables a determination of the correct polarity voltage to be applied in order to re-start the rotor 18 in a forward direction.

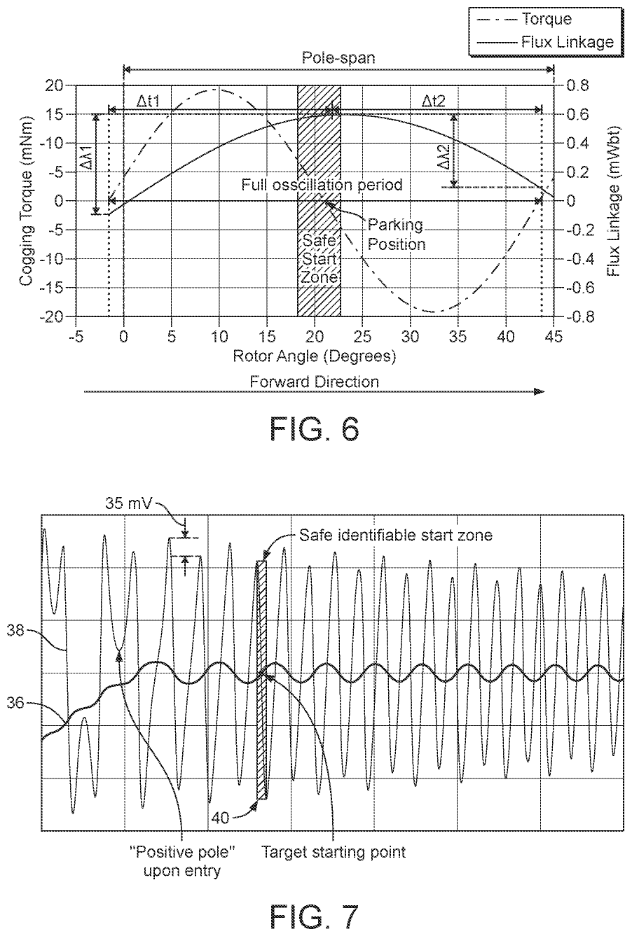

In view of the salient stator design, irrespective of whether the parking position of the rotor 18 is a positive parking position or a negative parking position, the flux linkage into the phase winding 22 from the rotor 18 is asymmetric about the parking position, as can be seen in FIG. 6, during a period of oscillation about the parking position. This asymmetry in flux linkage can be utilised in the manner described below to determine a parking position about which the rotor 18 oscillates.

During oscillation, the controller 34 monitors the back EMF induced in the phase winding 22, via signal bEMF, and from the back EMF the controller 34 is able to determine the parking position of the rotor 18. In particular, and referring to FIG. 6, the back EMF on a first side of the parking position can be represented as:

$$Vph 1 \approx \frac{Δ λ 1}{Δ t 1}$$

whilst the back EMF on a second side of the parking position can be represented as:

$$Vph 2 \approx \frac{Δ λ 2}{Δ t 2}$$

where Δλ1 is the difference between maximum and minimum flux linkage at a first boundary of oscillation on the first side of the parking position, Δλ2 is the difference between maximum and minimum flux linkage at a second boundary of oscillation on the second side of the parking position, and Δt1 and Δt2 are the time periods from the point at which maximum flux linkage occurs to the points at which minimum flux linkage occurs.

It can be seen that where Δt1=Δt2, and Δλ1>Δλ2, then Vph1>Vph2. We can therefore expect the peak back EMF values to be different either side of the parking position of the rotor.

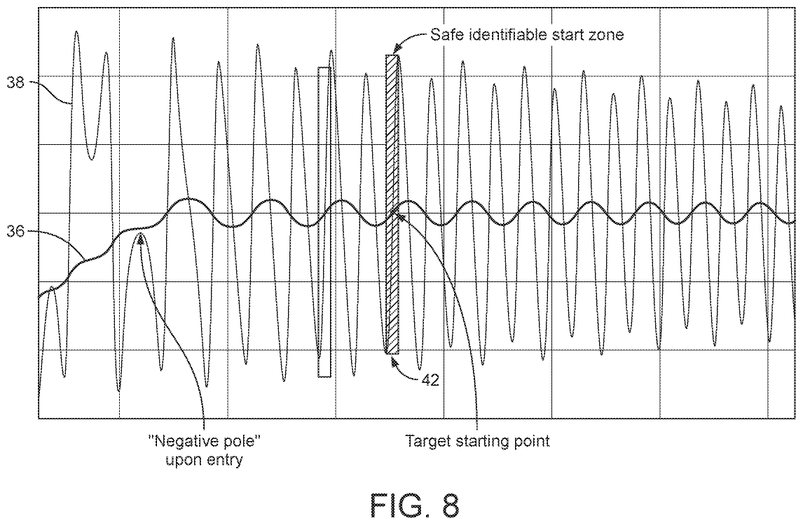

The back EMF value during oscillation of the rotor 18 about a positive parking position can be seen in FIG. 7, whilst the back EMF value during oscillation of the rotor 18 about a negative parking position can be seen in FIG. 8, with both FIG. 7 and FIG. 8 showing a superimposed rotor position signal 36 on a back EMF waveform 38.

As can be seen from FIG. 7, where the rotor 18 oscillates about a positive parking position, the back EMF induced in the phase winding 22 transitions from positive amplitude to negative amplitude at the parking position of the rotor 18, and transitions from negative amplitude to positive amplitude at a boundary position of oscillation of the rotor 18. Peak values of back EMF occur at positions between the parking position of the rotor 18 and the boundary positions of oscillation of the rotor 18.

A lower positive amplitude peak is experienced when the rotor 18 travels from a backward boundary of oscillation to the parking position in a forward direction when compared to a higher positive amplitude peak experienced when the rotor 18 travels from a forward boundary of oscillation to the parking position in a backward direction. A higher negative amplitude peak is experienced when the rotor 18 travels from the parking position to a forward boundary of oscillation in a forward direction when compared to a lower negative amplitude peak experienced when the rotor 18 travels from the parking position to a backward boundary of oscillation in a backward direction.

As can be seen from FIG. 8, where the rotor 18 oscillates about a negative parking position, the back EMF induced in the phase winding 22 transitions from negative amplitude to positive amplitude at the parking position of the rotor 18, and transitions from positive amplitude to negative amplitude at a boundary position of oscillation of the rotor 18. Peak values of back EMF occur at positions between the parking position of the rotor 18 and the boundary positions of oscillation of the rotor 18.

A higher positive amplitude peak is experienced when the rotor 18 travels from the parking position to a forward boundary of oscillation in a forward direction when compared to a lower positive amplitude peak experienced when the rotor 18 travels from the parking position to a backward boundary of oscillation in a backward direction. A lower negative amplitude peak is experienced when the rotor 18 travels from a backward boundary of oscillation to the parking position in a forward direction when compared to a higher negative amplitude peak experienced when the rotor 18 travels from a forward boundary of oscillation to the parking position in a backward direction.

These values of amplitude peak for both positive and negative parking positions are illustrated in Tables 1 and 2 below.

TABLE 1
“Positive Pole Pattern”

| | | | | | | | | |
|---|---|---|---|---|---|---|---|---|
| Vph_Pos | H | | L | | H | | L | |
| Vph_neg | | L | | H | | L | | H |

TABLE 2
“Negative Pole Pattern”

| | | | | | | | | |
|---|---|---|---|---|---|---|---|---|
| Vph_Pos | H | | L | | H | | L | |
| Vph_neg | | H | | L | | H | | L |

From Tables 1 and 2 above, it can be seen that for each of a positive and negative parking position of the rotor 18, a pattern in peaks of amplitude of back EMF induced in the phase winding 22 can be observed. Thus the controller 34, by monitoring amplitude peaks of back EMF induced in the phase winding 22, is able to determine which of a positive parking position and a negative parking position the rotor 18 is oscillating about.

In particular, a positive parking position of the rotor 18 is determined where a high positive amplitude peak is followed by a low negative amplitude peak and a low positive amplitude peak is followed by a high negative amplitude peak, and a negative parking position of the rotor 18 is determined where a high positive amplitude peak is followed by a high negative amplitude peak and a low positive amplitude peak is followed by a low negative amplitude peak.

Knowledge of the parking position of the rotor 18 is then used by the controller 34 to determine which polarity of drive voltage to apply in order to drive the rotor 18 in a forward direction to re-start the motor 14 from oscillation.

As well as knowing which polarity of voltage to apply, it is also important to know where the rotor 18 is relative to the parking position. The inventors of the present application have further recognised that the above discussed pattern in amplitude peaks of back EMF induced in the phase winding 22 can be used to determine where the rotor 18 is relative to the parking position.

In particular, and as discussed above, for a positive parking position of the rotor 18, a lower positive amplitude peak is experienced when the rotor 18 travels from a backward boundary of oscillation to the parking position in a forward direction when compared to a higher positive amplitude peak experienced when the rotor 18 travels from a forward boundary of oscillation to the parking position in a backward direction. A higher negative amplitude peak is experienced when the rotor 18 travels from the parking position to a forward boundary of oscillation in a forward direction when compared to a lower negative amplitude peak experienced when the rotor 18 travels from the parking position to a backward boundary of oscillation in a backward direction.

From this, we can infer that when the rotor 18 is oscillating about a positive parking position, a low positive amplitude peak in back EMF followed by a high negative amplitude peak in back EMF is indicative of the rotor 18 moving from a backward boundary of oscillation through the parking position to a forward boundary of oscillation, i.e. in a forward direction.

The controller 34 also calculates the time periods between amplitude peaks of back EMF induced in the phase winding 22, and then, with knowledge of the parking position, the correct polarity of drive voltage, and the inferred position of the rotor 18, uses the time periods to determine when to apply the drive voltage to the phase winding 22. In the case of the positive parking position discussed above, the time period between a low positive amplitude peak and an adjacent high negative amplitude peak is calculated to determine a time window in which a drive voltage can be applied to the phase winding 22 to drive the rotor 18 in a forward direction out of oscillation. Although described here as utilising the time between a low positive amplitude peak and a high negative amplitude peak to calculate the time window, it will be appreciated that other combinations of peaks, for example the time between two low positive amplitude peaks or the time between two high negative amplitude peaks, may also be used to calculate the necessary time window.

Once the time window is known, the controller 34 waits for a next determined low positive amplitude peak, for example the peak labelled 40 in FIG. 7, and sets a timer corresponding to the time window. The controller 34 sets the relevant switches, S1 and S4 in the case of FIG. 7 in view of the determined positive parking position, to apply the drive voltage at a time that is halfway through the time window, with such a time corresponding to the time during the oscillation of the rotor 18 at which the rotor 18 is at the parking position.

For a negative parking position of the rotor 18, a higher positive amplitude peak is experienced when the rotor 18 travels from the parking position to a forward boundary of oscillation in a forward direction when compared to a lower positive amplitude peak experienced when the rotor 18 travels from the parking position to a backward boundary of oscillation in a backward direction. A lower negative amplitude peak is experienced when the rotor 18 travels from a backward boundary of oscillation to the parking position in a forward direction when compared to a higher negative amplitude peak experienced when the rotor 18 travels from a forward boundary of oscillation to the parking position in a backward direction.

From this, we can infer that when the rotor 18 is oscillating about a negative parking position, a low negative amplitude peak in back EMF followed by a high positive amplitude peak in back EMF is indicative of the rotor 18 moving from a backward boundary of oscillation through the parking position to a forward boundary of oscillation, i.e. in a forward direction.

The controller 34 also calculates the time periods between amplitude peaks of back EMF induced in the phase winding 22, and then, with knowledge of the parking position, the correct polarity of drive voltage, and the inferred position of the rotor 18, uses the time periods to determine when to apply the drive voltage to the phase winding 22. In the case of the negative parking position discussed above, the time period between a low negative amplitude peak and an adjacent high positive amplitude peak is calculated to determine a time window in which a drive voltage can be applied to the phase winding 22 to drive the rotor 18 in a forward direction out of oscillation. Although described here as utilising the time between a low negative amplitude peak and a high positive amplitude peak to calculate the time window, it will be appreciated that other combinations of peaks, for example the time between two low negative amplitude peaks or the time between two high positive amplitude peaks, may also be used to calculate the necessary time window.

Once the time window is known, the controller 34 waits for a next determined low negative amplitude peak, for example the peak labelled 42 in FIG. 8, and sets a timer corresponding to the time window. The controller 34 sets the relevant switches, S2 and S3 in the case of FIG. 8 in view of the determined negative parking position, to apply the drive voltage at a time that is halfway through the time window, with such a time corresponding to the time during the oscillation of the rotor 18 at which the rotor 18 is at the parking position.

In the manner described above, the controller 34 determines the parking position about which the rotor 18 is oscillating, determines the correct polarity of drive voltage to be applied to the phase winding 22 to drive the rotor 18 in a forward direction out of oscillation, determines a relative position of the rotor 18 to the parking position, and calculates a time window during which the drive voltage can be applied to drive the rotor 18 in a forward direction out of oscillation.

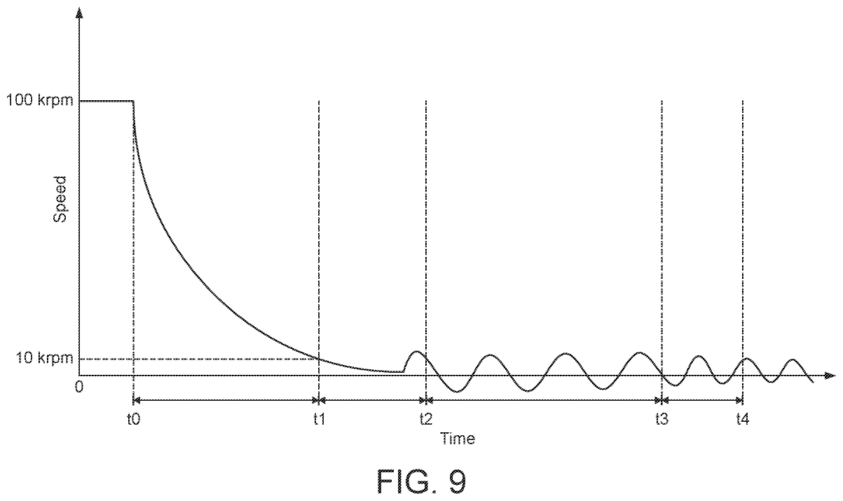

The present invention thereby enables the motor 14 to be safely re-started during oscillation. A modified shutdown sequence in accordance with the present invention is illustrated in FIG. 9.

Before time t0, the motor is operating in steady-state mode at a speed of around 100 krpm. The shutdown sequence is initiated at time t0, and between time t0 and t1 active braking is applied to the motor, for example by applying appropriate voltages to selected ones of switches Q1-Q4. This causes the motor to decelerate. During the time period t0-t1, the position of the rotor 18 can be monitored. In particular, the signal bEMF from the voltage sensor 33 is periodically monitored by turning switches Q1-Q4 off, and when the voltage transitions from negative to positive or positive to negative a phase voltage zero-crossing is deemed to occur. This allows the motor 14 to be re-started, if needed, during the time period t0-t1. The time period t0-t1 may be around 150-300 ms.

At time t1 the speed of the rotor 18 has dropped to around 10 krpm. Between time t1 and t2, the rotor 18 begins to oscillate about a parking position of the rotor 18. During the time period t1-t2, any possible restart of the motor 14 is delayed due to entry into oscillation, but the period of time for t1-t2 is relatively small, typically in the region of 50 ms, and may be minimised by braking, for example by applying appropriate voltages to selected ones of switches Q1-Q4. Between time t2 and t3, the rotor 18 oscillates about the parking position, and the controller 34 is able to determine safe re-start conditions in the manner described above. The time period of t2-t3 is typically in the region of 2s.

It will be appreciated that the methods described above are dependent on being able to distinguish between peaks in back EMF. The ability to use the methods may therefore be limited by resolutions of sensors, for example limited by measurement of voltage from the shunt current. A practical limit may be, for example, accurately distinguishing between amplitude peaks in rise time where the difference between amplitude peaks is 5 mV or more. When the oscillations of the rotor 18 are small, but not small enough to enable safe re-start, it may be possible to apply a current pulse to the motor 14 to increase the amplitude of oscillation such that the motor 14 reverts to the state of oscillation of t2-t3. This period of small amplitude oscillation indicated by the period t3-t4 in FIG. 9, and is typically less than 200 ms. After time t4, the oscillations are considered small enough that the motor 14 can be safely restarted in the forward direction.

As will be appreciated, by utilising the methods according to the present invention safe re-start of the motor 14 in a forward direction may be enabled over a greater time period during shut-down than for previous motors known in the art. This may reduce the risk of there being a delay in re-start when requested by a user, which may enhance user experience.

Whilst the method described above determines the parking position about which the rotor 18 is oscillating using an identified pattern in back EMF induced in the phase winding 22 during oscillation of the rotor 18, it will be appreciated that there may be other methods of determining rotor parking position that can be utilised along with utilising an identified pattern in back EMF induced in the phase winding 22 during oscillation of the rotor 18 to determine the relative position of the rotor 18 to the parking position.

For example, as can be seen in FIGS. 7 and 8, before the rotor 18 enters into oscillation, i.e. before a pattern of alternating positive and negative amplitude peaks in back EMF induced in the phase winding 22, the back EMF induced in the phase winding is a waveform that has characteristic pattern of double amplitude peaks, with a double positive amplitude peak being followed by a double negative amplitude peak, and so on. The polarity of the double amplitude peak before the rotor 18 enters oscillation is indicative of the parking position about which the rotor 18 oscillates, for example with a double positive amplitude peak immediately before entry into oscillation indicative of a positive parking position, and a double negative amplitude peak immediately before entry into oscillation indicative of a negative parking position. This the controller 34 is also able to determine which parking position the rotor 18 oscillates about by monitoring the back EMF induced in the phase winding 22 before entry into oscillation.

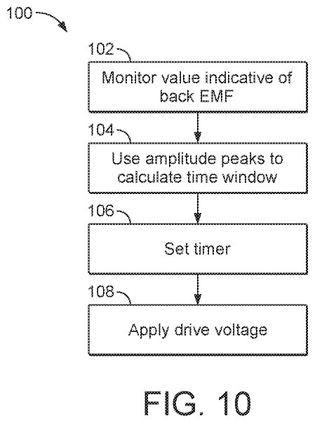

A first method 100 of controlling the motor 14 in accordance with the present invention is shown in the flow diagram of FIG. 10.

The method 100 comprises monitoring 102 a value indicative of back EMF induced in the phase winding 22 during oscillation of the rotor 18 about a parking position, and using 104 amplitude peaks of the value indicative of back EMF to calculate a time window in which to apply a drive voltage to the phase winding 22. The method 100 comprises setting 106 a timer corresponding to the time window at a subsequent determined amplitude peak, and applying 108 a drive voltage to the phase winding 22 during the time window.

By using amplitude peaks of a value indicative of back EMF induced in the phase winding 22 a direction of motion of the rotor 18 relative to the parking position may be inferred, and by using the amplitude peaks a time window can be calculated within which it is considered that an applied drive voltage will drive the rotor 18 in a forward, rather than a backward, direction.

By inferring the direction of the rotor 18 in such a manner and determining when an applied voltage will drive the rotor 18 in a forward, rather than a backward, direction, the motor 14 may be re-started during oscillation, which may reduce a delay of re-start compared to, for example, a motor where it is required to wait until the rotor is considered to be stationary for re-start to occur.

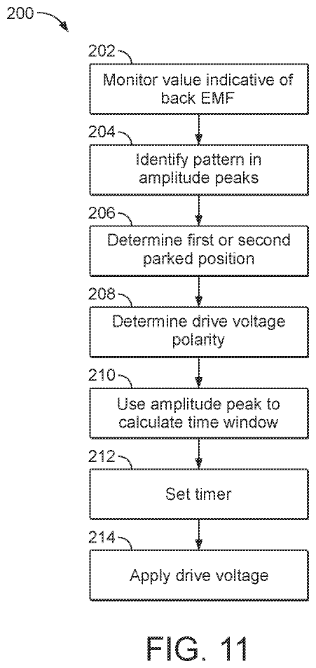

A second method 200 of controlling the motor 14 in accordance with the present invention is shown in the flow diagram of FIG. 11. The method 200 of FIG. 11 comprises similar steps to the method 100 of FIG. 10, but also includes steps to determine which of two parking positions the rotor 18 is oscillating about.

The method 200 comprises monitoring 202 a value indicative of back EMF induced in the phase winding 22 during oscillation of the rotor 18 about a parking position, and identifying 204 a pattern in amplitude peaks of the value indicative of back EMF. The method 200 comprises using the pattern in amplitude peaks of the value indicative of back EMF to determine 206 whether the parking position of the rotor 18 is a first parking position or a second parking position, and determining 208 a voltage polarity of the drive voltage to be applied to the phase winding based on the determined first or second parking position. The method 200 comprises using 210 the amplitude peaks of the value indicative of back EMF to calculate a time window in which to apply a drive voltage to the phase winding 22, setting 212 a timer corresponding to the time window at a subsequent determined amplitude peak, and applying 214 a drive voltage to the phase winding 22 during the time window.

The method 200 allows determination of the parking position of the rotor 18 during oscillation by monitoring a value indicative of back EMF induced in the phase winding 22 during oscillation of the rotor 18 about a parking position. Knowledge of the parking position of the rotor 18 may enable determination of the correct polarity of drive voltage to apply to the phase winding 22 to drive the rotor 18 in a forward direction. Then, by utilising amplitude peaks in the value indicative of back EMF induced in the phase winding 22, a direction of motion of the rotor 18 relative to the parking position may be inferred, and by using the amplitude peaks a time window can be calculated within which it is considered that an applied drive voltage will drive the rotor 18 in a forward, rather than a backward, direction.

By inferring the direction of the rotor 18 in such a manner and determining when an applied voltage will drive the rotor in a forward, rather than a backward, direction, the motor 14 may be re-started during oscillation, which may reduce a delay of re-start compared to, for example, a motor where it is required to wait until the rotor is considered to be stationary for re-start to occur.

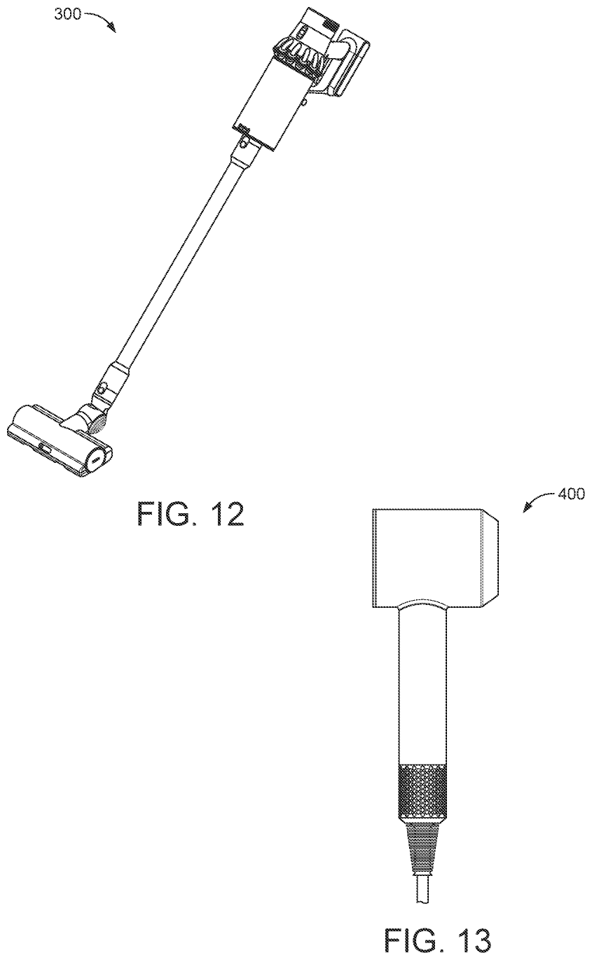

A vacuum cleaner 300 incorporating the motor system 10 according to the present invention is illustrated schematically in FIG. 12, whilst a haircare appliance 400 incorporating the motor system 10 according to the present invention is illustrated schematically in FIG. 13.

1. A method of controlling a brushless permanent-magnet motor having a phase winding and a rotor, the method comprising:
monitoring a value indicative of back EMF induced in the phase winding during oscillation of the rotor about a parking position;
using amplitude peaks of the value indicative of back EMF to calculate a time window in which to apply a drive voltage to the phase winding;
setting a timer corresponding to the time window at a subsequent determined amplitude peak; and
applying a drive voltage to the phase winding during the time window.

2. The method as claimed in claim 1, wherein the method comprises using negative amplitude peaks of the value indicative of back EMF to calculate the time window in which to apply the drive voltage to the phase winding.

3. The method as claimed in claim 1, wherein the method comprises using positive amplitude peaks of the value indicative of back EMF to calculate the time window in which to apply the drive voltage to the phase winding.

4. The method as claimed in claim 1, wherein the method comprises using a time difference between a consecutive negative amplitude peak and positive amplitude peak of the value indicative of back EMF to calculate the time window.

5. The method as claimed in claim 4, wherein the parking position is one of a first parking position and a second parking position, the first parking position comprises a positive parking position, the second parking position comprises a negative parking position, the method comprises using a time difference between a low positive amplitude peak and a high negative amplitude peak to calculate the time window when the rotor is oscillating about the first parking position, and the method comprises using a time difference between a low negative amplitude peak and a high positive amplitude peak to calculate the time window when the rotor is oscillating about the second parking position.

6. The method as claimed in claim 1, wherein the drive voltage is applied to the phase winding at a halfway point of the time window.

7. The method as claimed in claim 1, wherein the drive voltage is applied to the phase winding when the value indicative of back EMF induced in the phase winding is zero.

8. The method as claimed in claim 1, wherein the method comprises identifying whether the parking position of the rotor is a first parking position or a second parking position, and determining a voltage polarity of the drive voltage to be applied to the phase winding based on the determined first or second parking position.

9. The method as claimed in claim 8, wherein the method comprises identifying a pattern in amplitude peaks of the value indicative of back EMF, and using the pattern in amplitude peaks of the value indicative of back EMF to determine whether the parking position of the rotor is the first parking position or the second parking position.

10. The method as claimed in claim 9, wherein the method comprises identifying a pattern in negative amplitude peaks of the value indicative of back EMF to determine whether the parking position of the rotor is the first parking position or the second parking position.

11. The method as claimed in claim 9, wherein the method comprises identifying a pattern in positive amplitude peaks of the value indicative of back EMF to determine whether the parking position of the rotor is the first parking position or the second parking position.

12. The method as claimed in claim 9, wherein the first parking position is determined where a high positive amplitude peak is followed by a low negative amplitude peak and/or where a low positive amplitude peak is followed by a high negative amplitude peak.

13. The method as claimed in claim 9, wherein the second parking position is determined where a high positive amplitude peak is followed by a high negative amplitude peak and/or where a low negative amplitude peak is followed by a low negative amplitude peak.

14. The method as claimed in claim 9, wherein the method comprises identifying a pattern in amplitude peaks of the value indicative of back EMF over at least four amplitude peaks.

15. The method as claimed in claim 8, wherein the method comprises monitoring a value indicative of back EMF prior to oscillation of the rotor about the parking position, and identifying a polarity of the value indicative of back EMF prior to oscillation to determine whether the parking position of the rotor is the first parking position or the second parking position.

16. The method as claimed in claim 15, wherein the first parking position is determined where a positive polarity of the value indicative of back EMF is identified prior to entry of the rotor into oscillation, and the second parking position is determined where a negative polarity of the value indicative of back EMF is identified prior to entry of the rotor into oscillation.

17. A method of controlling a brushless permanent-magnet motor having a phase winding and a rotor, the method comprising:
monitoring a value indicative of back EMF induced in the phase winding during oscillation of the rotor about a parking position;
identifying a pattern in amplitude peaks of the value indicative of back EMF;
using the pattern in amplitude peaks of the value indicative of back EMF to determine whether the parking position of the rotor is a first parking position or a second parking position;
determining a polarity of drive voltage to be applied to the phase winding dependent on the determined first or second parking position; and
applying a drive voltage having the determined polarity to the phase winding.

18. A brushless permanent-magnet motor comprising a stator, a phase winding wound about the stator, a rotor rotatable relative to the stator, and a control system to perform the method as claimed in claim 1.

19. The brushless permanent-magnet motor as claimed in claim 18, wherein the control system comprises an inverter, a gate driver module, a controller, and a current sensor, the inverter coupled to the phase winding, the gate driver module to drive opening and closing of switches of the inverter in response to control signals output by the controller, and the current sensor to output a signal that provides a measure of the current in the phase winding.

20. A floorcare device comprising the brushless permanent-magnet motor as claimed in claim 18.

21. A haircare appliance comprising the brushless permanent-magnet motor as claimed in claim 18.
